(19) United States
(12) Patent Application Publication
(10) Pub. No.: US 2022/0046902 A1
(43) Pub. Date: Feb. 17, 2022

(54) BEEHIVES, BEEHIVE COMB FRAMES, AND METHODS FOR KEEPING HONEY BEES

(71) Applicant: David Freedman, Raymerton, NY (US)

(72) Inventor: David Freedman, Raymerton, NY (US)

(21) Appl. No.: 17/444,805

(22) Filed: Aug. 10, 2021

Related U.S. Application Data
(60) Provisional application No. 63/064,568, filed on Aug. 12, 2020.

(51) Int. Cl. A01K 47/02; A01K 47/06

(52) U.S. Cl. CPC A01K 47/02; A01K 47/06

(57) ABSTRACT

Beehives, beehive comb frames, and methods of for keeping honey bees are provided. The beehives include a housing; at least one enclosure in the housing having a top, a bottom, and sides; at least one elongated rod extending horizontally between two of the sides of the at least one enclosure; and a plurality of comb frames adapted to receive honeycomb, each of the plurality of comb frames having a mounting mechanism, for example, a hook, adapted to releasably engage the at least one elongated rod. The beehive comb frames include a top bar; two side pieces extending from opposing ends of the top bar; and at least one mounting mechanism, such as, a hook, attached to the top bar, the mounting mechanism adapted to releasably engage a hive enclosure. The beehives and comb frames are uniquely adapted to facilitate maintenance of the hives and the harvesting of honey.

### CROSS-REFERENCE TO RELATED APPLICATION

This application claims priority from pending U.S. Provisional Patent Application 63/064,568, filed on Aug. 12, 2020, the disclosure of which is included by reference herein in its entirety.

### BACKGROUND OF THE INVENTION

### Technical Field

The present invention generally relates to beehives. More particularly, the present invention relates to beehives having vertically suspended beehive comb frames that facilitate the handling and servicing of the comb frames and the harvesting of the honey combs and honey produced in the comb frames by bees. Aspects of the invention include passages for bees to go from one compartment in the beehive to another compartment that may decrease the tendency of the bees to undesirably swarm.

### Description of Related Art

As generally known in the apiarian (that is, beekeeping) art, there are typically three types of modern beehives: 1) the Langstroth hive; 2) the top-bar hive; and 3) the AZ or Slovenian hive. The well-known Langstroth hive is old and successful; it is described in U.S. Pat. No. 9,300 issued in 1852. The Langstroth hive typically comprises a series of stacked boxes, or “supers,” where each the boxes contain a series of vertically hanging hive comb frames, for example, 8 to 10 comb frames. Though a historically successfully hive, the Langstroth hive and its variations are cumbersome to handle, for example, due to the stacked boxes that need to be pried open and lifted to access the comb frames and honey from the lower comb frames. In addition, each honey-laden stacked box of a Langstroth hive can weigh up to a hundred pounds, and thus can be difficult for the beekeeper to handle and move, for example, creating increased potential to strain a beekeeper's back.

The top-bar hive, or Kenyan hive, simply comprises one long covered box that is opened from the top and contains a series of pieces of wood that serve as places for bees to form honeycomb. Again, though simple and inexpensive, the top-bar hive can be effective in producing honey, buy its production capacity is limited. In addition, the honey-laden structures of a top-bar hive are typically difficult to remove from the hive. Also, further disadvantages of the top-bar hive are that top-bar hives typically take up a lot of space, the honey-laden structures of top-bar hives are difficult to separate, and top-bar hives typically do not prevent the bees from swarming. As known in the art, “swarming” means that the bees will leave the existing hive due, for example, overcrowding, and undesirably seek or develop another hive remote from the existing hive.

The AZ or Slovenian hive is a Langstroth type hive that, unlike the conventional Langstroth hive, opens from the back. However, the typical AZ hive has frames stacked on top of one another like the Langstroth hive and uses rectangular frames set on a wire base. It is recognized in the beekeeping art that, though the frames of the AZ hive may be easier for the beekeeper to access and handle, the AZ hive is typically more restrictive for the bees.

Accordingly, there is exists a need in the art for improved beehives, improved beehive comb frames, and improved methods of beekeeping. Aspects of the present invention overcome the above disadvantages and other limitations of prior art beehives, beehive comb frames, and methods of beekeeping.

### SUMMARY OF THE INVENTION

The present invention in its several embodiments and multiple aspects provides an improved beehive, improved beehive comb frames, and improved methods of keeping honeybees that address many of the disadvantages of the prior art. Specifically, aspects of the invention provide beehives having comb frames that can be suspended within the beehive while being readily accessible to the beekeeper from, for example, the back of the beehive for handling, inspection and harvesting. In addition, according to some aspects to the invention, the resident bees are allowed to move from one hive in one enclosure to an adjacent hive in another enclosure through one or more ports or passages. These ports or passages may be opened and closed by the beekeeper to assist in the expansion of the beehive and the prevention of a swarming and undesirable loss of bees. In one aspect, instead of leaving the existing hive by swarming, for example, due to overcrowding, the resident bees may be exposed to an adjacent enclosure by exposing ports or passages through which the bees may pass to generate an adjacent hive or populate an adjacent hive. Accordingly, in this aspect, the bees can be maintained by the beekeeper and not, for example, lost to another hive.

One embodiment of the invention is a beehive comprising or including: a housing; at least one enclosure in the housing, the at least one enclosure having an internal cavity having a top, a bottom, and sides; at least one elongated rod extending horizontally between two of the sides of the internal cavity of the at least one enclosure; and a plurality of comb frames adapted to receive brood comb and/or honeycomb, each of the plurality of comb frames having a mounting mechanism adapted to releasably engage the at least one elongated rod. In one aspect, the mounting mechanism may be at least one hook. In another aspect, each of the plurality of comb frames may vertically extend from the at least one elongated rod when releasably engaged to the at least one elongated rod. In another aspect, the at least one enclosure may be a plurality of enclosures, for example, at least 4 enclosures. The elongated rod may be a metallic rod.

In another aspect, the beehive may further include at least one aperture communicating between at least two of the plurality of enclosures, and a rotatable or deflectable cover positioned over the at least one aperture. Typically, a plurality of apertures between enclosures and associated covers may be provided.

In another aspect, when the plurality of comb frames is mounted in the at least one enclosure, a space may be provided between the plurality of comb frames and the bottom of the at least one enclosure. In one aspect, at least one of the plurality of comb frames may have an open bottom, wherein the open bottom of the at least one of the plurality of comp frames allows honeycomb to extend into the space between the plurality of comb frames and the bottom of the at least one enclosure. In one aspect, the bottom of the enclosure may be removed or omitted to allow the growing hive to extend substantially unobstructed from the comb frame and, for example, extend into a lower enclosure.

Another embodiment of the invention is a beehive comb frame comprising or including: a top bar; two side pieces extending from opposing ends of the top bar; and a mounting mechanism attached to the top bar, the mounting mechanism adapted to releasably engage a hive enclosure. In one aspect, the sidepieces comprise distal ends defining an open bottom. In another aspect, the mounting mechanism may be a mechanism or device attached between the ends of the top bar. In another aspect, the mounting mechanism may be positioned substantially equally distant from the ends of the top bar.

In one aspect, the mounting mechanism on the comb frame may be at least one hook, for example, a metal hook.

Another embodiment of the invention is a method of keeping bees, the method comprising or including: suspending a plurality of comb frames within a cavity in an enclosure of a beehive; positioning at least one queen bee within the enclosure having the suspended comb frames; allowing honey-producing bees to populate the enclosure and produce at least some honey on one of the plurality of suspended comb frames; and removing at least one of the plurality of suspended comb frames having honey from the enclosure.

In one aspect, suspending the plurality of comb frames may be practiced by suspending the plurality of comb frames from an elongated rod mounted in the cavity of the enclosure.

In another aspect, the method may further include, after positioning the at least one queen bee, substantially isolating the cavity, the comb frames, and the at least one queen bee from the local environment, for example, by closing the entrance and/or doors of the beehive.

In another aspect, the method may further include harvesting honey from the at least one of the plurality of suspended comb frames having honey.

In a further aspect, the enclosure may comprise a first enclosure, and the method may further include providing a second enclosure sharing at least one passage with the first enclosure; and allowing at least some bees to pass through the at least one passage from the first enclosure to the second enclosure. In one aspect, the method may further include regulating passage of at least some bees through the at least one passage from the first enclosure to the second enclosure, for example, by providing at least one gate about the at least one passage from the first enclosure to the second enclosure, for example, at least one “nuc” gate, as disclosed herein.

In one aspect, the at least one passage shared by the first enclosure and the second enclosure may be an internal passage, for example, at least one opening or port through a shared wall of the first enclosure and the second enclosure.

In another aspect, the method may further comprise or include suspending a second plurality of comb frames within a cavity in the second enclosure; positioning at least one second queen bee within the second enclosure having the second plurality of suspended comb frames; and allowing honey-producing bees to populate the second enclosure and produce at least some honey on one of the second plurality of suspended comb frames. In one aspect, the method may include preventing the at least one second queen bee from passing from the second enclosure to the first enclosure, for example, by positioning at least one gate about the at least one passage, for example, a nuc gate, as disclosed herein.

One aspect of the invention may be marketed under the name “Two Bee Hive Hotel” by Two Bee Honey of Troy, N.Y. The Two Bee Hive Hotel may have multiple enclosures, that is, “hotel rooms” or “apartments,” for receiving the comb frames disclosed herein and developing one or more colonies of bees.

These and other aspects, features, and advantages of the invention will become apparent from the following detailed description of the various aspects of the invention taken in conjunction with the accompanying drawings.

### BRIEF DESCRIPTION OF THE DRAWINGS

The subject matter, which is regarded as the invention, is particularly pointed out and distinctly claimed in the claims at the conclusion of the specification. The foregoing and other objects, features, and advantages of the invention will be readily understood from the following detailed description of aspects of the invention taken in conjunction with the accompanying drawings in which:

FIG. 1 is a rear perspective view of a beehive according to one aspect of the invention.

FIG. 2 is a front perspective of the beehive shown in FIG. 1.

FIG. 3 is a detailed perspective of a portion of the beehive shown in FIG. 1 identified by Detail 3 in FIG. 1 showing a plurality of comb frames.

FIG. 4 is another perspective view similar to FIG. 3 showing the plurality of comb frames.

FIG. 5 is a perspective view of a comb frame mounted in the beehive shown in FIGS. 1 through 4 according to an aspect of the invention.

FIG. 6 is a side elevation view of the comb frame and beehive shown in FIG. 5, partially in cross section.

### DETAILED DESCRIPTION OF THE INVENTION

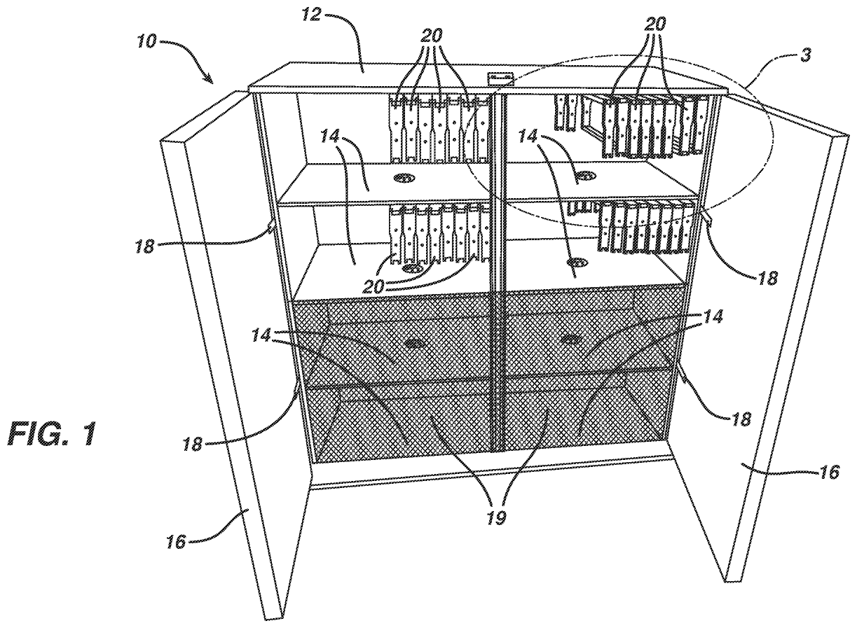

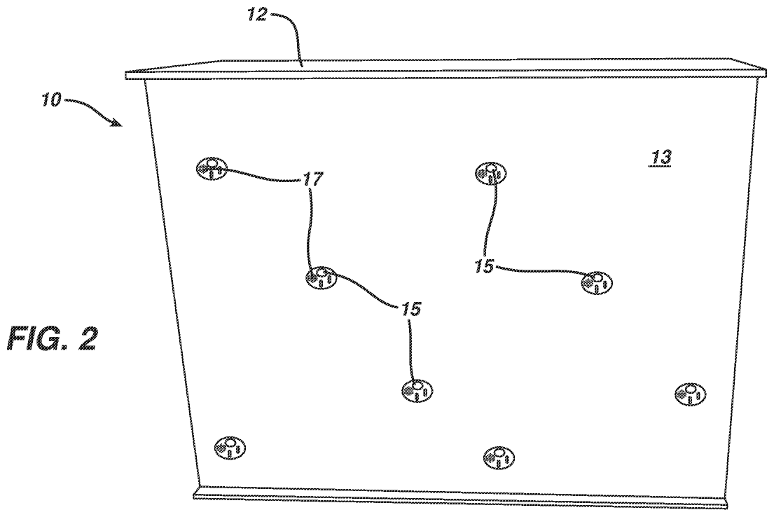

FIG. 1 is a rear perspective view of a beehive 10 according to one aspect of the invention. FIG. 2 is a front perspective of the beehive 10 shown in FIG. 1. As shown in FIG. 1, beehive 10 includes a housing 12 having enclosures 14, for example, a plurality of enclosures or “apartments” 14. As shown in FIG. 1, housing 12 may include an open side having one or more removable covers or doors 16, for example, two or more doors 16 pivotally mounted to housing 12 via one or more hinges 18. Doors 16 may include one or more securing or locking devices, such as, a dead bolt or clasp. In one aspect, the components of beehive 10 may be fabricated from wood, for example, plywood, but it is envisioned that beehive 10 may be fabricated from any convenient material, including one or more plastics or from a metal, such as, an aluminum or a stainless steel.

As shown in FIG. 2, beehive 10 typically includes a front panel or wall 13 of housing 12, and front panel 13 may include a plurality of holes or apertures 15 which communicate with the enclosures or “apartments” 14, shown in FIG. 1, allowing bees to enter beehive 10. According to one aspect of the invention, holes 15 may include a restriction or cover 17, for example, a rotatable or deflectable cover by which holes 15 may be opened and closed as desired to allow or prevent bees from entering or exiting beehive 10. In one aspect, covers 17 may be “bee entrance gates,” or “nucleus hive entrance gates,” or “nuc gates,” as known in the art, or their equivalent. The nuc gates may be metallic or plastic, and are available from various suppliers.

As shown in FIG. 1, according to aspects of the invention beehive 10 includes at least one honeycomb frame 20, or, simply, a comb frame 20, but typically beehive 10 includes one or more comb frames 20, for example, 10 or more, or 20 or more comb frames 20. According to aspects of the invention, each comb frame 20 may be removably mounted in enclosure 12, for example, removably mounted whereby each comb frame 20 is suspended in a substantially vertical orientation. For instance, suspended in a substantially vertical orientation may comprise each comb frame 20 defining a plane, and the plane of the comb frame 20 is oriented substantially perpendicular to ground level and/or substantially parallel to the vertical side walls of enclosure 12.

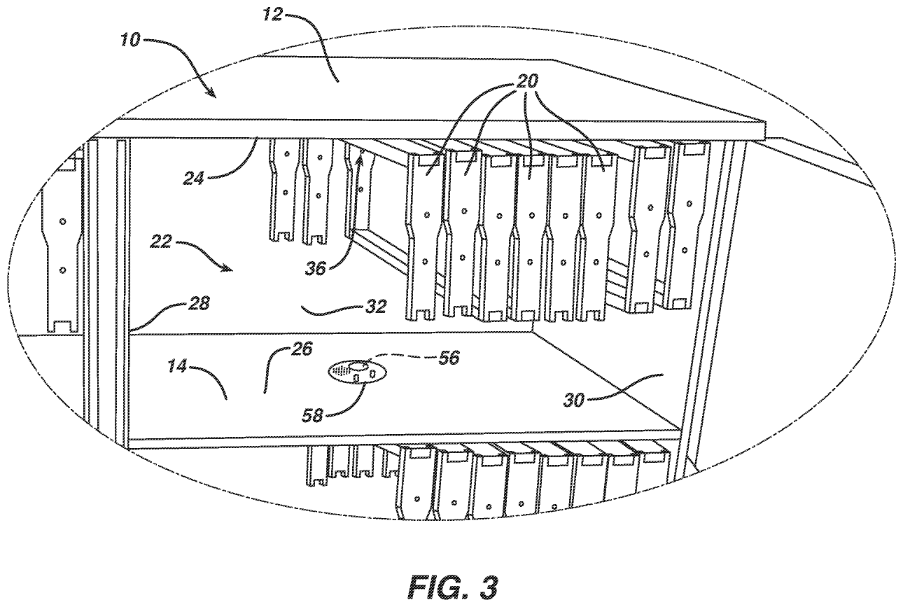

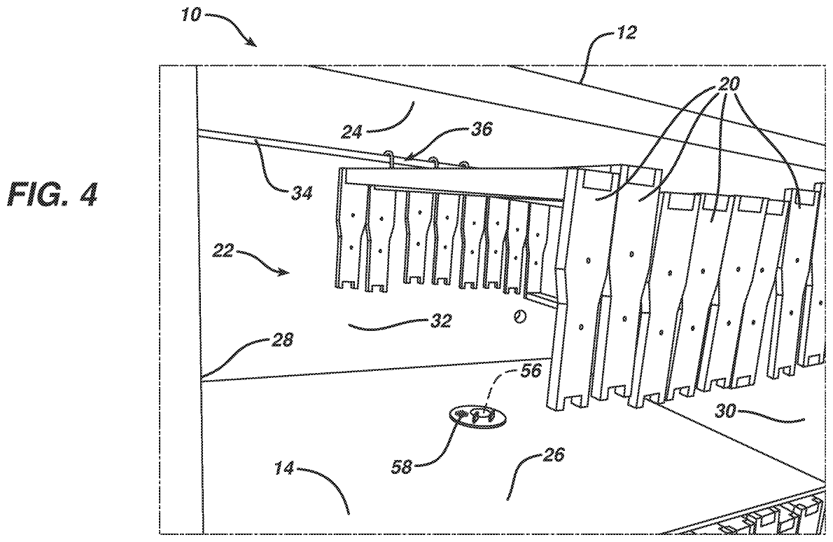

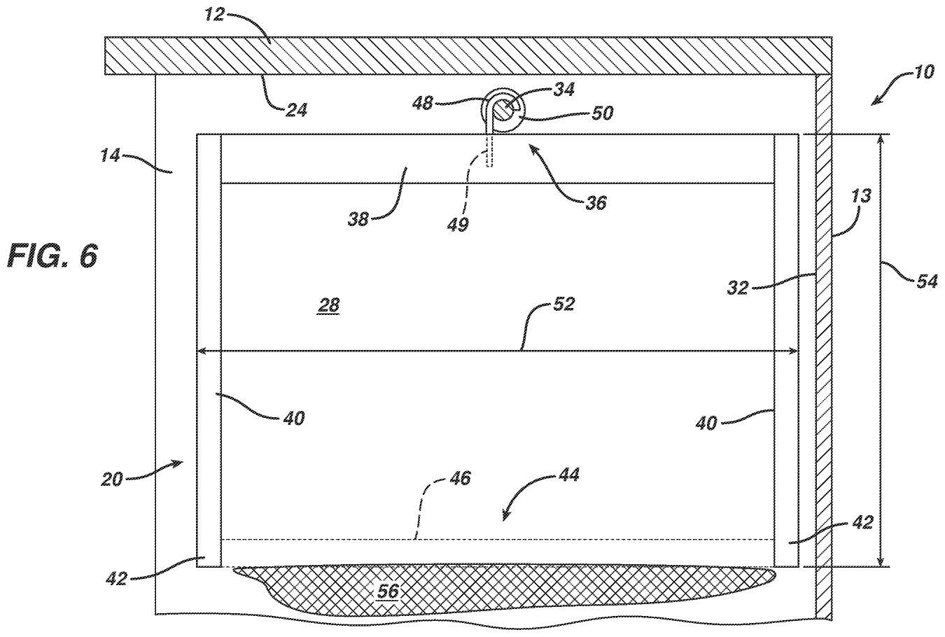

FIG. 3 is a detailed perspective of a portion of the beehive 10 shown in FIGS. 1 and 2 identified by Detail 3 in FIG. 1 showing a plurality of comb frames 20. FIG. 4 is another perspective view similar to FIG. 3 showing the plurality of comb frames 20. As shown in FIGS. 3 and 4, in one aspect, the beehive 10 may include at least one enclosure 14 having an internal cavity 22 having a top 24, a bottom 26, and sides 28, 30, and 32. As shown in FIG. 4, beehive 10 may also include at least one elongated rod or bar 34. Rod or bar 34 may typically extend substantially horizontally between two of the sides 28 and 30 of the internal cavity 22 of the at least one enclosure 14. Beehive 10 also includes a plurality of comb frames 20 adapted to receive honeycomb, where each of the plurality of comb frames 20 has a mounting mechanism or device 36 adapted to releasably engage the at least one elongated rod 34. Side 32, or the rear side, of enclosure 14 may be the opposite side of panel 13 (see FIG. 2) of the front of beehive 10. In one aspect, the mounting mechanism 36 may be at least one hook or clasp, though other mechanisms adapted to releasably mount a comb frame 20 to rod 34 can be used. The details of one mounting mechanism 36 that may be used are shown and described with respect to FIG. 6 below.

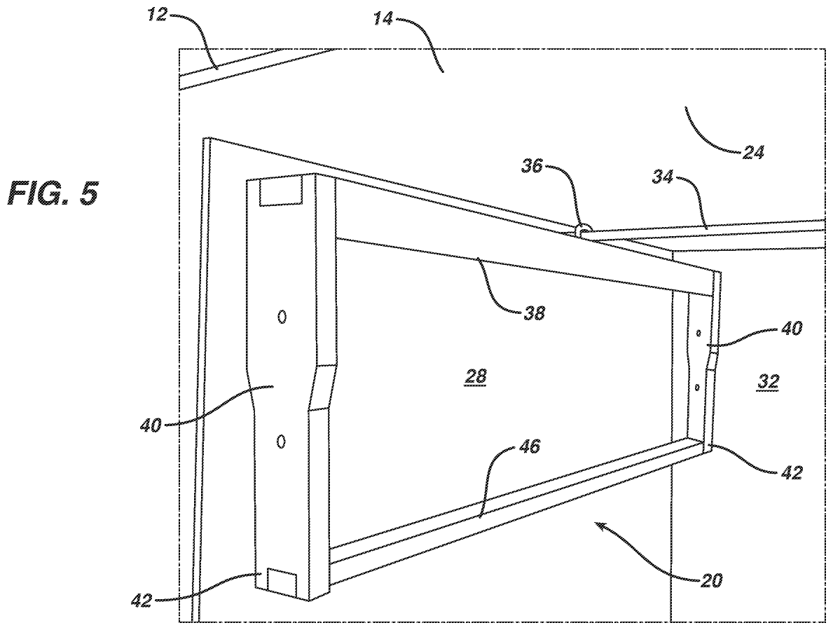

FIG. 5 is a perspective view of a comb frame 20 mounted in the enclosure 14 of housing 12 of beehive 10 shown in FIGS. 1 through 4 according to an aspect of the invention. FIG. 6 is a side elevation view of the comb frame 20 mounted in enclosure 14 of housing 12 of beehive 10 shown in FIG. 4, partially in cross section. As shown in FIGS. 5 and 6, each of the plurality of comb frames 20 may vertically extend from the at least one elongated rod 34 when releasably engaged to the at least one elongated rod 34. For example, when mounted to rod 34 by mounting mechanism or device 36, each comb frame 20 may define a plane that is substantially vertical; for instance, each comb frame 20 may define a plane substantially perpendicular to the plane of the top 24 and/or substantially parallel to the plane of the side 28.

As shown in FIGS. 5 and 6, each comb frame 20 may typically be substantially rectangular in shape, for example, having a rectangular foot print, though it is envisioned that comb frame 20 may be fabricated in other shapes, including square. As shown in FIGS. 5 and 6, beehive comb frame 20 may include a top bar 38 and two side pieces 40 extending from opposing ends of the top bar 38. In one aspect, shown most clearly in FIG. 6, the side pieces 40 may have distal ends 42 defining an open bottom 44, though in other aspects, comb frame 20 may have a bottom bar 46 (shown in FIG. 5, and shown in phantom in FIG. 6) extending between the distal ends 42 of side pieces 40. Comb frame 20 may also typically include the mounting mechanism or device 36 attached to the top bar 38, and, as disclosed herein, the mounting mechanism 36 may be adapted to releasably engage elongated rod 34 mounted in the hive enclosure 14.

In one aspect, as shown in FIG. 6, bottom bar 46 may be omitted and comb frame 20 may have an open bottom 44 between side pieces 40. According to this aspect of the invention, the formation of honeycomb hive is not limited to the dimensions of comb frame 20, but may extend beyond or beneath the open bottom 44 of comb frame 20. For example, due to the vertical orientation of the mounting of comb frame 20 within beehive 10, where the honey comb can be attached to and supported by the top bar 38 and/or side pieces 40, the formation of honey comb by the resident bee colony may not be limited to the extents of the comb frame 20, for example, by the bottom bar 46, but honey comb may be formed beneath or below the extents of comb frame 20, for example, as indicated by the position of honey comb 56 shown in FIG. 6. In addition, by providing spacing below the lower extremities of the open bottom 44 of comb frame 20, as shown, for example, in FIGS. 1 through 5, the growth of honeycomb 56 and the production of honey may be enhanced, for example, may increase comb and honey production over a hive having comb frames with a closed bottom 46. In one aspect, the bottom of the enclosure 14, for example, the bottom 26 (shown in FIG. 4) of enclosure 14 may be removed or omitted to allow the growing honey comb 56 to extend unobstructed from the comb frame 20 and, for example, extend into a lower enclosure 14. According to aspects of the invention, the honeycomb 56 extending below the frame 20 may be harvested as needed, for example, by simply separating or cutting off the extended honeycomb 56 from frame 20, and thus allowing bees to regenerate comb 56 and honey. In one aspect, for example, in contrast to harvesting of the Langstroth hive, the harvesting of the comb and honey by removal of comb 56 from the bottom of frame 20 may not disturb or agitate the queen bee, which typically resides in the comb above comb 56 within the frame 20, and thus, according to aspects of the invention, may advantageously not be undisturbed by the removal of comb 56.

As shown most clearly in FIG. 6, in one aspect, the mounting mechanism or device 36 attached to the top bar 38 of comb frame 20 may comprise a hook or hook-like structure 48 mounted to top bar 38, for example, mounted to the top surface of top bar 38. In one aspect, hook or hook-like structure 48 may be mounted in or about the middle of the span of top bar 38, though in other aspects, hook or hook-like structure 48 may be mounted anywhere along the span of top bar 38. In one aspect, mounting device 36 may include one or more hooks 48 mounted to top bar 38 and adapted to engage rod 34. For example, in one aspect, one or more hooks 48 may include a threaded or non-threaded shank 49 that can engage or be threaded into top bar 38, with or without a pilot hole. It is envisioned that many conventional mechanisms may be used for mounting mechanism or device 36 to releasably engage rod 34. For example, in one aspect, mounting mechanism or device 36 may be a “cup hook,” such as, a ⅝-inch cup hook available from a local hardware store, or its equivalent.

In one aspect, the mounting mechanism or device 36 may comprise one or more cooperating elongated rails or tubes mounted to the top 24 of internal cavity 22 and to top bar 38. For example, one elongated rail may be mounted to top 24 and a cooperating elongated rail may be mounted to top bar 38 that may translate with, for example, be extracted with, frame 20 from enclosure 14, for example, completely extracted. The cooperating rails may facilitate, for example, inspection or harvesting of the hive formed on frame 20 by the beekeeper. In one aspect, a rail-like mounting mechanism may facilitate the handling and manipulation of a relatively heavy, honey-laden frame 20. As known in the art, a honey-laden frame 20 may weigh from 7 to 10 pounds. After inspection or harvesting, the rail on the top bar 38 of frame 20 may then be re-engaged with the rail on top 24 and frame 20 may be re-inserted into place in enclosure 14. In one aspect, the rails may be telescoping rails, where the frame 20 may be extracted from enclosure 14 while maintaining engagement and support of the extracted frame 20. In another aspect, the cooperating rails, telescoping or non-telescoping, may include one or more stops, for example, engageable and dis-engageable stops, that when engaged prevent the movement or extraction of the frame 20 from enclosure 14, for example, only when the beekeeper disengages the stop. The cooperating rails may include friction-reducing materials or devices, for example, roller bearings or friction reducing bearings, which facilitate extraction and insertion of frame 20. The friction reducing material may, for example, be a polytetrafluoroethylene (PTFE), such as, a DuPont Teflon® PTFE, or its equivalent, or a Saint-Gobain Rulon® PTFE or its equivalent.

In one aspect, the mounting mechanism or device 36 may comprise one or more rails or tubes mounted to top 24 of internal cavity 22 or to top bar 38 and one or more devices, for example, hooks or rollers, mounted to top 24 or to top bar 38 that engage the rail or tube and support frame 20 during extraction or insertion of frame 20. Other rail-like devices known in the art may be used for mounting mechanism or device 36, and will be apparent to those of skill in the art.

As also shown in FIG. 6, rod 34 may be mounted to opposing walls 28 and 30 by conventional means, for example, using two opposing mounting brackets or flanges 50 mounted to opposing walls 28 and 30 and adapted to receive and support rod 34. It is envisioned that many conventional devices may be used for mounting rod 34 to opposing walls 28 and 30. For example, in one aspect, opposing walls 28 and 30 may include through holes or blind holes sized to receive and retain support rod 34.

In one aspect, rod or bar 34 may be any elongated member mounted between opposing walls 28 and 30 and/or to top 24 and adapted to engage and support comb frames 20. In one aspect, rod 34 may be metallic, plastic, or wooden. For example, in one aspect, rod 34 may be a cylindrical rod made from a metal, for example, an aluminum or a steel, a plastic, a wood, any other material, or a combination thereof. Rod 34 may be hollow or solid, and may comprise one integral piece or a series of separate, combinable pieces. Though shown generally circular in cross section in FIG. 6, it is envisioned that rod 34 may be non-circular, for example, elliptical or polygonal in cross section, while providing the desired function disclosed herein. In one aspect, the function of rod 34 may be provided a sufficiently taut cord, wire, or rope, for example, a cord extending between sides 28 and 30 and drawn taut to provide a substantially rigid structure to engage hook 38, or its equivalent structure.

According to aspects of the invention, comb frame 20 may have dimensions that vary broadly depending on the size and/or dimensions of beehive 10 and enclosures 14. For example, in one aspect, comb frame 20 may have a width 52 ranging from 6 inches to 30 inches, but typically have a width 52 ranging from 16 inches to 24 inches, for example, 18 inches in width. In one aspect, comb frame 20 may have a height 54 ranging from 4 inches to 24 inches, but typically have a height 54 ranging from 4 inches to 8 inches, for example, 6 inches in height. In one aspect, comb frame 20 may have a thickness (not shown) ranging from ½ inch to 4 inches, but typically have a thickness ranging from ½ inch to 2 inches, for example, ¾ inches in thickness. In one aspect, comb frame 20 may comprise a modified conventional Langstroth-type comb frame where, when modified, the Langstroth comb frame is compatible with aspects of the invention. For example, in one aspect, modifying a Langstroth-type comb frame by removing the “ears” of the Langstroth-type comb frame may provide comb frame 20.

As shown most clearly in FIG. 1, according to aspects of the invention, housing 12 of beehive 10 may include one or more (for example, a plurality of) enclosures or “apartments” 14 holding one or more comb frames 20. For example, though housing 12 shown in FIG. 1 includes eight (8) enclosures 14, aspects of the invention may include only a single enclosure 14, two or more enclosures 14, 4 or more enclosures 14 or, for example, 10 to 20 or more enclosures 14. However, in one aspect, for example, to facilitate the handling and limit the weight of beehive 10, the number of enclosures 14 may be limited to 4 to 10 enclosures 14, for instance, the 8 enclosures 14 shown in FIG. 1.

According to aspects of the invention, enclosures 14 may have dimensions that vary broadly depending on the size and/or dimensions of beehive 10 and comb frames 20. For example, in one aspect, enclosures 14 may have a width ranging from 12 inches to 48 inches, but typically have a width ranging from 18 inches to 30 inches, for example, 24 inches in width. In one aspect, enclosures 14 may have a height ranging from 8 inches to 24 inches, but typically have a height ranging from 10 inches to 12 inches, for example, 12 inches in height. In one aspect, enclosures 14 may have a depth ranging from 12 inches to 36 inches, but typically have a depth ranging from 18 inches to 24 inches, for example, 18 inches deep.

As shown most clearly in FIGS. 3 and 4, housing 12 may include one or more apertures, portals, holes, or passages 56 between enclosures 14 allowing communication between enclosures 14 to, for example, allow bees to pass from one enclosure 14 to another enclosure 14 (or from one housing 12 to another housing 12). One or more apertures, portals, holes, or passages 56 may be located in a top 24, a bottom 26, and/or a side 28, 30, or 32 of an enclosure 14, and one or more apertures, portals, holes, or passages 56 may be located per top 24, per bottom 26, and/or per side 28, 30, or 32 of an enclosure 14. According to one aspect of the invention, holes 56 may include a restriction or cover 58, for example, a deflectable or rotatable cover 58 by which holes 56 may be restricted, partially restricted, and/or closed as desired to allow or prevent bees from passing though to an adjacent enclosure 14. Cover 58 may be similar to rotatable cover 17 shown in FIG. 2, for example, an entrance gate or nuc gate provided by various suppliers, or its equivalent.

It is also envisioned that aspects of the invention that beehive 10 may include two or more housings 12, each containing one or more enclosures 14. The two or more housings 12 may be isolated from each other or may share common sides, tops, bottoms, portals, holes, or apertures, for example, through which bees may pass. These portals or apertures may include obstructions, gates, or restrictions for limiting or preventing the passage of bees, for example, one or more of the rotatable covers 17, 58 disclosed herein. In another aspect, two or more housings 12 having enclosures 14 may communicate via one or more passages or conduits, for example, passages, conduits, or bridges communicating between two or more enclosures 12 that may be positioned adjacent to or distant from each other.

According to aspects of the invention, the beehive 10 disclosed in FIGS. 1 through 6 can be an effective means for promoting the generation of honeycomb and honey by bees while facilitating the handling, maintenance, servicing, and inspection of the beehive 10, the enclosures 14, and the comb frames 20, and the harvesting of honey. In one aspect, beehive 10 facilitates beekeeping by providing an upright, easily accessible enclosure 12 for handling, inspecting, and harvesting comb frames 20, and the honey and honey produced by bees on comb frames 20. For example, according to an aspect of the invention, the desired comb frame 20, for example, a frame 20 shown in FIGS. 5 and 6 (such as, a “brooding frame” or a “honey-gathering frame,” as known in the art), may be mounted in beehive 10 by first opening doors 16 to expose the enclosures 14, where each enclosure 14 has a transverse frame-mounting rod 34, as shown in FIGS. 4, 5, and 6. The beekeeper can then mount as many frames 20, with or without bottom bar 46, by engaging mounting mechanism or device 36, for example, a hook 48 (as shown in FIG. 6), to mount one more frames 20 in one or more enclosures 14.

According to aspect of the invention, and as known in the art, in order to maximize honey production, a beekeeper may limit the number of enclosures 14 populated by frames 20 in order to allow a bee colony to develop on the limited frames 20 mounted in beehive 10. For example, in one aspect, only one enclosure 14 centrally-located in housing 12 may be populated with frames 20 to allow a bee colony to develop in the centrally-located enclosure 14. Before or after mounting frames 20 in selected enclosure 14, the selected enclosure may be isolated from adjacent enclosures 14 by obstructing the portals 56 with covers 58 (see FIGS. 3 and 4) preventing bees from migrating to adjacent enclosures 14. Once mounted in beehive 10, local bees may access comb frames 20 by entering beehive 10 and comb frames 20 via the open portals 15 on, for example, the front panel 13, of beehive 10. Access by bees to the inactive or unselected enclosures 14 may be minimized or prevented by obstructing the portals 15 of the unselected enclosures 14, for example, by closing covers 17.

As known in the art, bee colonies may be initiated by introducing a “brood” comb frame having one queen bee into an enclosure, for example, by mounting the brood comb frame as shown in FIGS. 5 and 6, and thus attracting bees to the hive to enhance the size of the bee colony in the selected enclosure while minimizing or preventing the creation of a bee colony in other enclosures 14. As known in the art, bees will then generate honey comb and honey on comb frames 20, that is, honey-producing frames, in the same enclosure 14 holding the brood comb having the queen.

After mounting the appropriate comb frames 20 into the selected enclosures 14, the inside of the beehive 10 and any comb frames 20 may be substantially isolated from the outside environment by closing doors 16. Doors 16 may be secured in the closed position by one or more latches or dead bolts. In one aspect, enclosures 14 in beehive 10 may also be isolated by mounting a barrier or cover 19 (see FIG. 1) over the opening of the enclosures 14 to also limit migration of bees between enclosures 14. For example, in one aspect, barrier 19 may be a flexible barrier, such as, a plastic netting mounted to the enclosures 14, for instance, removably mounted by hook and loop fasteners (such as, Velcro® brand hook and loop fasteners). In another aspect, the barrier or cover 19 may be a substantially rigid barrier, for example, a panel, a sheet, or a board mounted over the opening of one or more enclosures 14. Barrier 19 may be made of a wood, a metal, or a plastic. In one aspect, the barrier may be transparent, translucent, or substantially opaque. The barrier 19 may be mounted to beehive 10 by conventional means, including hook and loop type fasteners or mechanical fasteners. In one aspect, barrier 19 may be mounted to beehive 10 by hinges or hooks where barrier 19 may be opened to access enclosures 14, and secured in an open position, for example, with a retaining rod or a hook.

The beehive 10 may then be allowed to be populated by bees, for example, bees present in the surrounding environment and/or bees introduced from elsewhere, and the bees are allowed to generate honey comb and honey within the comb frame 20 in the selected and isolated enclosures 14.

After sufficient time, depending upon, among other things, weather conditions and the local bee population, the beekeeper may then inspect the progress of the comb and honey formation or the status of the bee colony by accessing the comb frames 20 in beehive 10. Typically, according to aspects of the invention, the beekeeper may access beehive 10 by first opening doors 16, and, if present, removing the flexible barrier 19 to expose the comb frames 20. According to aspects of the invention, the comb frames 20 may be inspected by simply manually unhooking comb frame 20 from transverse bar 34 and manually withdrawing the comb-containing frame 20 from beehive 10 for inspection. A comb frame separating tool, or “hive tool,” may be used to separate the frames 20 should bee's wax and/or “propolis,” that is, the resinous mixture or “bee glue” produced by bees, as known in the art, between comb frames 20 interfere with comb frame removal. However, in one aspect, due to the positioning and available lateral spacing of the comb frames 20 in enclosures 14, little or no wax my form between adjacent combs frames and a hive tool may not be needed to remove wax and honey-containing comb frames from beehive 10.

According to one aspect of the invention, this manual removal of a brood frame or of a honey frame 20 may be markedly facilitated by aspects of the invention, especially, compared to conventional hives, for example, compared to the Langstroth hives. As known in the art, Langstroth hives typically comprises vertically stacked boxes or “supers” holding multiple closely packed comb frames. In order to open and access the frames of a Langstroth hive, for example, for inspection, servicing, and/or harvesting, the top most stacked box must first be uncovered, and, to access the lower boxes, the upper boxes must be removed. However, as known in the art, the honeycomb and honey-containing stacked Langstroth boxes can be relatively heavy, for example, weighing 50 to 70 pounds or more, and the removal of such boxes can be difficult or impossible for beekeepers having limited strength, maneuverability, and/or dexterity. In contrast, the relatively easily accessible, vertically mounted comb frames 20 of beehive 10 avoid this disadvantage of the prior art hives.

In addition, experience has found that opening, accessing, removing, and inspection of comb frame 20 in beehive 10 has shown to be less agitating to the bee colony. According to aspects of the invention, less agitation of the bees can greatly facilitate access and inspection of the colony and comb frames 20. This contrasts with the well-known experiences with existing hives, such as, the Langstroth hives, where opening and separation of the boxes and comb frames can dramatically disrupt and thus undesirably agitate the bees.

Aspects of the present invention circumvent this disadvantage of the prior art beehives and their handling, by providing easily accessible comb frames 20, which even though weighted down with comb and honey may be handled, removed, inspected, and/or harvested by simply dismounting, for example, unhooking, comb frames 20 from transvers bar 34. In one aspect, due to the upright positioning of comb frames 20 in beehive 10, beekeepers may access and handle comb frames 20 while seated in front of the open beehive 10, or even by kneeling in front of open beehive 10 Furthermore, after removal and inspection, according to aspects of the invention, comb frames 20 may be remounted into beehive 10 by simply re-attaching comb frames 20 to transverse bar 34 and simply closing doors i6.

Once the comb frames 20 are inspected and any servicing performed, the inspected comb frames 20 can be replaced into the enclosure 14 for further comb and honey production. In one aspect, should additional honey and comb be desired, once the comb and honey containing frames 20 are re-mounted within the selected enclosure 20, further enclosures 20 may be exposed to the existing colony by opening covers 17 and/or 58 to allow access of bees to one or more adjacent, previously unpopulated enclosures 14. In one aspect, one or more comb frames 20 may be introduced to an adjacent unoccupied enclosure 20 to allow bees to access and form comb and honey in the adjacent enclosure to increase the size of the colony and increase the honey production. In one aspect, one or more queen bees may be introduced to the adjacent, previously unpopulated enclosure, for example, from the existing bee colony or from another source, to promote the generation of an increased colony or of a different colony, for example, a different colony of bee species. According to aspects of the invention, access or prevention of access to adjacent enclosures may be provided by the covers 17 and/or 58, for example, one or more nuc gates. For example, according to aspects of the invention, one or more nuc gates 17 may be provided between adjacent enclosures to, for instance, regulate, limit, or prevent passage of bees between enclosures 14 to, for example, segregate or split a hive or colony. In one aspect, at least one of the covers 17 and/or 58 may prevent passage of queen bees between enclosures, for example, provide what may be referred to as a “queen excluder” gate between enclosures 14.

In addition, according to one aspect of the invention, two or more colonies of bees, for example, having different queen bees, may be kept in one beehive 10 and the two or more colonies substantially isolated from each other. Obstructing appropriate holes 15 and/or 56 may effect the isolation of colonies, though it is understood that complete isolation of colonies may not practically be possible. In one aspect, two or more different colonies of bees may be kept and substantially isolated in beehive 10. In one aspect, an ease of maneuverability of the bees can be provided for the beekeeper and/or the bees, which may help prevent overcrowding and/or swarming of beehive 10 with little or no disruption to the bees in beehive 10.

As disclosed herein, beehives, comb frames, and methods of beekeeping are provided that overcome the disadvantages of the prior art. Aspects of the invention provide beehives and comb frames that facilitate the handling of comb frames that minimizes the time and effort for arranging the beehive with comb frames, inspecting the bee colony during and after colony formation and honey production, and harvesting the honey. Aspects of the invention have also been shown to enhance the viability of the bees, for example, during inclement weather. In contrast, for example, to the Langstroth hive, the hives disclosed herein have been shown to enhance bee survival during off-season, for example, during winter snow. In addition, in contrast, for example, to the Langstroth hive, aspects of the invention may not require off-season storage, for example, winter storage, of hive frames or “supers.” Also, aspects of the invention have proven to provide enhanced protection from predators, for example, bears, that can be prevented from accessing the hives due to the enclosed housing.

The terminology used herein is for the purpose of describing particular embodiments only and is not intended to be limiting of the disclosure. As used herein, the singular forms “a,” “an,” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed.

The description of the present disclosure has been presented for purposes of illustration and description, but is not intended to be exhaustive or limited to the disclosure in the form disclosed. Many modifications and variations will be apparent to those of ordinary skill in the art without departing from the scope and spirit of the disclosure. The embodiments were chosen and described in order to best explain the principles of the disclosure and the practical applications, and to enable others of ordinary skill in the art to understand the disclosure for various embodiments with various modifications as are suited to the particular use contemplated.

1. A beehive comprising:
a housing;
at least one enclosure in the housing, the at least one enclosure having an internal cavity having a top, a bottom, and sides;
at least one elongated rod extending horizontally between two of the sides of the internal cavity of the at least one enclosure; and
a plurality of comb frames adapted to receive brood comb or honeycomb, each of the plurality of comb frames having a mounting mechanism adapted to releasably engage the at least one elongated rod.

2. The beehive as recited in claim 1, wherein the mounting mechanism comprises at least one hook.

3. The beehive as recited in claim 1, wherein each of the plurality of comb frames vertically extends from the at least one elongated rod when releasably engaged to the at least one elongated rod.

4. The beehive as recited in claim 1, wherein the at least one enclosure comprises a plurality of enclosures.

5. The beehive as recited in claim 4, wherein the plurality of enclosures comprises at least 4 enclosures.

6. The beehive as recited in claim 4, wherein the beehive further comprises at least one aperture communicating between at least two of the plurality of enclosures.

7. The beehive as recited in claim 5, wherein the beehive further comprises deflectable cover on the at least one aperture.

8. The beehive as recited in claim 1, wherein when the plurality of comb frames is mounted in the at least one enclosure a space is provided between the plurality of comb frames and the bottom of the at least one enclosure.

9. The beehive as recited in claim 8, wherein at least one of the plurality of comb frames comprises an open bottom, and wherein the open bottom of the at least one of the plurality of comb frames allows honeycomb to extend into the space between the plurality of comb frames and the bottom of the at last one enclosure.

10. The beehive as recited in claim 1, wherein the at least one elongated rod comprises a metallic rod.

11. A beehive comb frame comprising:
a top bar;
two side pieces extending from opposing ends of the top bar; and
at least one mounting mechanism attached to the top bar, the mounting mechanism adapted to releasably engage a hive enclosure.

12. The beehive comb frame as recited in claim 11, wherein the sidepieces comprise distal ends defining an open bottom.

13. The beehive comb frame as recited in claim 11, wherein the at least one mounting mechanism comprises a mechanism or device attached between ends of the top bar.

14. The beehive comb frame as recited in claim 13, wherein the at least one mounting mechanism comprises a mounting mechanism positioned substantially equally distant from the ends of the top bar.

15. The beehive comb frame as recited in claim 11, wherein the at least one mounting mechanism comprises at least one hook.

16. The beehive comb frame as recited in claim 11, wherein the at least one mounting mechanism comprises at least one metal hook.

17. A method of keeping bees, the method comprising:
suspending a plurality of comb frames within a cavity in an enclosure of a beehive;
positioning at least one queen bee within the enclosure having the suspended comb frames;
allowing honey-producing bees to populate the enclosure and produce at least some honey on one of the plurality of suspended comb frames; and
removing at least one of the plurality of suspended comb frames having honey from the enclosure.

18. The method as recited in claim 17, wherein suspending the plurality of comb frames comprises suspending the plurality of comb frames from an elongated rod mounted in the cavity of the enclosure.

19. The method as recited in claim 17, wherein the method further comprises, after positioning the at least one queen bee, substantially isolating the cavity, the comb frames, and the at least one queen bee from local environment.

20. The method as recited in claim 17, wherein the method further comprises harvesting honey from the at least one of the plurality of suspended comb frames having honey.

20-31. (canceled)
